(19) United States
(12) Patent Application Publication
(10) Pub. No.: US 2005/0196206 A1
(43) Pub. Date: Sep. 8, 2005

(54) Image forming apparatus

(75) Inventor: Koji Arimura, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/793,732

(22) Filed: Mar. 8, 2004

(51) Int. Cl. G03G 21/00

(52) U.S. Cl. 399/350

(57) ABSTRACT

In an image forming apparatus which includes: an image bearing member; a transfer member that transfers a toner image formed on the image bearing member to a transfer material; and a cleaning member that is brought into abutment against the image bearing member to remove toner remaining on the image bearing member after the toner image is transferred onto the transfer material, and in which toner prepared by a polymerizing method is used for formation of the toner image, a degree of compaction C of the toner is set to be within a range of 10 to 30%.

### BACKGROUND OF THE INVENTION

1. Field of the Invention

The present invention relates to an image forming apparatus such as a copying machine or a printer, and more specifically to an image forming apparatus equipped with a cleaning member for cleaning toner remaining on an image bearing member after a toner image is transferred to a transfer material.

2. Related Background Art

Conventionally, various image forming apparatuses employing an electrophotographic process or the like, such as a copying machine and a printer, have been put into practical use. In the electrophotographic process, an electrostatic image is formed on a surface of an image bearing member such as a photoconductive member, and after the electrostatic image is developed and transferred to a transfer material, the surface of the image bearing member is cleaned and the electrostatic image forming process is carried out again.

A method of using a cleaning blade as the cleaning member is widely adopted as the method of cleaning the image bearing member. With this method, an elastic plate formed of urethane rubber or the like, for example, is brought into pressure contact with the surface of the image bearing member. That is, one side of the elastic plate is held by a holder (holding member), and the cut edge on the other side of the elastic plate is brought into pressure contact with the surface of the image bearing member by utilizing the elasticity of the elastic plate. Then, the elastic plate and the image bearing member are moved relative to each other so that residual toner on the image bearing member is removed by the above-mentioned edge portion as it slides on the image bearing member.

In recently years, toner produced by a polymerizing method (hereinafter referred to as “polymerizing toner”) is often used, particularly in full-color image forming apparatuses. As compared with toner produced by the conventional pulverizing method, polymerization toner provides high sphericity of particles, and is superior in terms of the particle diameter uniformity and transferability.

However, polymerization toner, the production of which involves a binding reaction of molecules in a suspension, exhibits no surface irregularities and has a surface property that is approximately close to a true sphere, and hence closest packing can easily occur. As a result, convection of toner, which positively contributes to the cleaning property, does not occur, making it extremely difficult to clean transfer residual toner. Further, there is also a problem in that toner slips through the cleaning blade in the abutting portion (cleaning region) between the cleaning blade and the image bearing member, making it impossible to attain stable cleaning performance.

As a measure for improving the cleaning property of polymerization toner, Japanese Patent Application Laid-open No. 09-106096 proposes a toner with a small particle diameter whose loosen apparent density A (g/cm³) and whose volume-average particle diameter D (μm) satisfy the following relationship: 29≦100A−D≦35, and whose aspect ratio (sphericity) falls within the range of 1.25 to 1.40. Although the cleaning property of transfer residual toner can be secured by making the sphericity of toner particles be farther away from the true sphere, it becomes difficult to attain favorable transferability that is a characteristic of polymerization toner, which may lead to appearance of mottled solid images upon transfer, thickening of printed characters, and occurrence of scumming.

In addition, as another method of improving the cleaning property of polymerization toner, there is known a method of increasing the abutment force between the leaning blade as the cleaning member and the image bearing member. When using this method for a certain type of toner, however, the slidability of the cleaning blade with respect to the image bearing member is lost in the first place before any improvement in cleaning property can be attained by increasing the abutment force, causing such problems as noise, chatter, and turning up of the cleaning blade which may in turn cause a degradation in the function of the cleaning device.

In order to improve the cleaning property, Japanese Patent Applicaion Laid-Open No. 11-288194, for example, proposes a method for attaining improved slidability by applying a solid lubricant, such as zinc sterate, to the image bearing member by using a cleaning brush. This method, however, involves the following problems. That is, the brush becomes necessary, which adds complexity to the construction. Further, it is difficult to apply the solid lubricant to the surface of the image bearing member uniformly, which in turn makes it difficult to ensure long-term stability of the applied solid lubricant.

In addition, there is also an example in which, for instance, a cleaning auxiliary member such as a brush roller is attached forward of the cleaning blade in the rotational direction of the image bearing member. However, this arrangement adds complexity to the construction, and there is a fear of clogging occurring in the brush roller serving as the cleaning auxiliary member when a large amount of transfer residual toner is supplied to the cleaning region, causing a degradation in the function thereof.

Incidentally, as conventional primary charging means for charging the image bearing member, in addition to a corona charger, there is widely used a charger using a conductive roller having a multi-layer structure in which expanded conductive rubber is formed as a base layer on rod-like core metal. In a charging method using such a conductive roller, the conductive roller is brought into press-contact with the image bearing member so as to rotate following the rotation of the image bearing member, thereby effecting contact charging. Then, a bias obtained by superimposing on a DC voltage an AC voltage having a peak-to-peak voltage that is twice or higher than the charging start voltage is applied to the conductive roller. Regarding the bias to be applied to the conductive roller at this time, the DC voltage is controlled to a constant voltage, and the AC voltage is controlled to a constant current. By thus applying the AC voltage to the conductive roller, the surface potential of the image bearing member can be readily converged to a target potential as compared with a case in which only the DC voltage is applied.

With the image forming apparatus in which an AC/DC bias is applied in the primary charging process as described above, when, in particular, the cut edge portion of the cleaning blade is brought into abutment against the downside of the image bearing member, the cleaning blade generates noise each time several tens to several hundreds of sheets are printed after the power is turned on, and turning up of the cleaning blade may occur in the worst case.

The noise or turning up of the cleaning blade occurs due to an increase in the frictional force between the cleaning blade and the image bearing member. The above-mentioned frictional force is stable in the state in which fine particles of extraneous additives, which are present on the toner surface, are separated from the toner surface as transfer residual toner supplied to a cleaning region builds up near the cut edge of the cleaning blade to undergo convection, and the separated fine particles are retained in a nip portion of the cleaning blade.

However, in an image forming apparatus in which the image bearing member is charged by applying a DC voltage and an AC voltage to the conductive roller, in particular, the cleaning blade and the image bearing member oscillate due to the AC bias, causing the fine particles retained on the abutment surface (cleaning nip portion) between the cleaning blade and the image bearing member to slip from the abutment surface. Then, unless fine particles are supplied to the toner in the cleaning region, the friction between the cleaning blade and the image bearing member increases. As a result, noise, chatter, turning up, etc. of the cleaning blade occur, causing degradation in the function of the cleaning device.

As a measure for preventing such toner depletion occurring near the cut edge of the cleaning blade, for example, there is proposed a method of supplying the toner supplied to the image bearing member to the cleaning region by performing development immediately after the turning-on of the image forming apparatus or each time a predetermined number of sheets are printed.

However, particularly with the arrangement of the cleaning blade such that its cut edge portion abuts the downside of the image bearing member, no substantial effects are observed unless toner is supplied to the cleaning region for a considerable number of times, for example, several tens of times.

Further, there is also proposed a method of providing a toner loosening member, or a member for retaining toner that has been cleaned once, near the cut edge of the cleaning blade and combining the member with the cleaning blade. However, attachment accuracy is required in attaching the above member near the cleaning blade. In addition, there is a fear that toner slips out of the cleaning region when a large amount of toner is supplied to the cleaning region.

### SUMMARY OF THE INVENTION

In view of the above problems, an object of the present invention is to provide an image forming apparatus capable of forming a high-quality image at all times by maintaining the cleaning performance of the cleaning member over a long period of time.

Another object of the present invention is to provide an image forming apparatus capable of preventing toner from slipping through the cleaning member even when using spherical toner produced by a polymerizing method which is difficult to be cleaned away when present as transfer residual toner.

Further, still another object of the present invention is to provide an image forming apparatus which is capable of preventing toner depletion from occurring near the cleaning member even when toner does not readily accumulate in a cleaning region due to the arrangement of the cleaning member, and which is capable of preventing, in particular, noise or turning up of the cleaning member from occurring immediately after the power is turned on.

To attain the above objects, according to the present invention, there is provided an image forming apparatus including: an image bearing member; a counter-type blade for removing toner formed on the image bearing member, wherein: assuming that the blade inroads into the image bearing member, an inroad amount λ (mm) of the blade is 0.9≦λ≦1.5; an angle 0 formed between the blade and a tangential plane of the image bearing member in an abutting portion of the blade with the image bearing member is 18°≦0<90°; a value of a shape factor SF-1 of the toner is not smaller than 100 and not larger than 120; and a degree of compaction C of the toner is not smaller than 10% and not larger than 30%.

Preferably, the degree of compaction of the toner is measured with the following measurement method and is obtained based on the expression (1) below.

[Measurement method] A 400-mesh sieve (sieve opening: 150 μm), a 200-mesh sieve (sieve opening: 75 μm), and a 100-sieve (sieve opening: 38 μm) are overlaid on top of one another from above in the order of increasing sieve opening, and 5 g of the toner is placed on the 100-mesh sieve, and a weight of toner remaining on each of the sieves after applying an oscillation having an amplitude of 0.5 mm and a frequency of 50 Hz to the 100-mesh sieve for fifteen seconds is measured to obtain the degree of compaction C based on the expression (1).
Degree of compaction C (%)−a weight of toner on the 100-mesh sieve (g) 5(g)×100+a weight of toner on the 200-mesh sieve (g) 5(g)×35+a weight of toner on the 400-mesh sieve (g) 5(g)×15 1).

### BRIEF DESCRIPTION OF THE DRAWINGS

FIG. 1 is a schematic diagram showing an image forming apparatus according to an embodiment of the present invention;

FIG. 2 is an explanatory view illustrative of an inroad amount λ and a set angle θ of a cleaning blade with respect to an image bearing member:

FIG. 3 is an explanatory view illustrative of a nip width “a” of the cleaning blade:

FIG. 4 is a schematic diagram showing an image forming apparatus according to another embodiment of the present invention;

FIG. 5 is an explanatory view illustrative of a position where the cleaning blade comes into contact with the image bearing member; and

FIG. 6 is a schematic diagram showing an image forming apparatus according to still another embodiment of the present invention.

### DESCRIPTION OF THE PREFERRED EMBODIMENTS

### First Embodiment

(Overall Structure and Operation of Image Forming Apparatus)

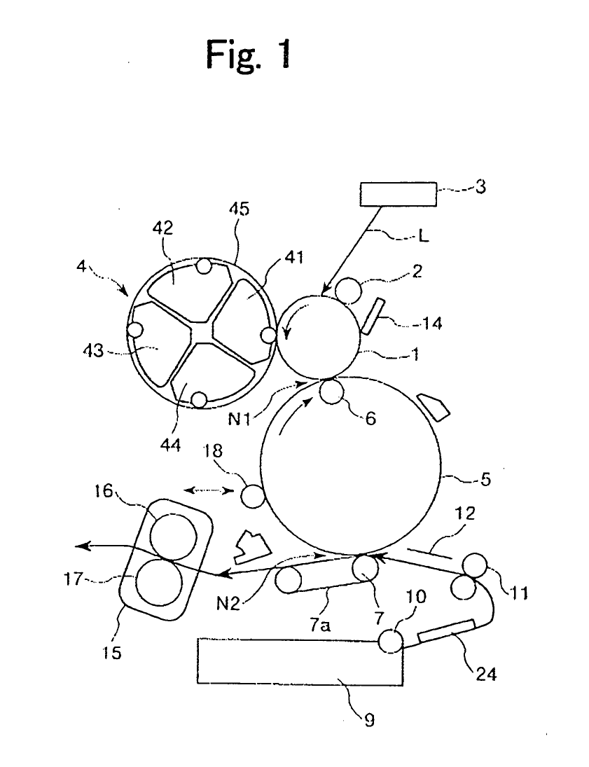

First, description is made of overall structure and operation of an image forming apparatus according to this embodiment of the present invention. FIG. 1 schematically shows an overall structure of an image forming apparatus 100 of this embodiment. In this embodiment, the image forming apparatus 100 is a color-image forming apparatus of an intermediate transfer system employing an electrophotographic process, such as a copying machine or a laser beam printer.

The image forming apparatus 100 includes as a first image bearing member a rotary drum type electrophotographic photosensitive member (hereinafter, referred to as “photosensitive drum”) that is repeatedly used. A photosensitive drum 1 is rotated at a predetermined peripheral speed (process speed) in a counterclockwise direction as indicated by the arrow of FIG. 1.

The photosensitive drum 1 is uniformly charged to a predetermined potential with a predetermined polarity by a primary charger 2 as the photosensitive drum 1 rotates. In this embodiment, used for the primary charger 2 is a multilayer conductive roller that has rod-like core metal covered with expanded conductive rubber as a base layer. The conductive roller is rotated in accordance with the rotation of the photosensitive drum 1 in press-contact therewith. Thus, contact charging is performed. A bias obtained by superimposing, on a DC voltage, an AC voltage having a peak-to-peak voltage that is twice or higher than a charging start voltage is applied to the conductive roller. At this time, the DC voltage is controlled to a constant voltage, and the AC voltage is controlled to a constant current. By thus applying the AC voltage to the conductive roller, the surface potential of the photosensitive member 1 can be readily converged to a target potential as compared with a case in which only the DC voltage is applied. In this embodiment, an AC component is a sinusoidal current having a frequency of about 1,300 Hz. A current value is set to about 1,900 μA.

Next, the charged photosensitive drum 1 surface receives image exposure L with an image exposure means 3 (color-original image color separation/imaging exposure optical system, scanning exposure system using a laser scanner outputting a laser beam modulated according to a time-series electric digital pixel signal of image information, etc.). As a result, an electrostatic latent image is formed according to a target component image. Thereafter, the electrostatic latent image is developed with color fine particles (toner) by a rotary developing device 4 as developing means.

The rotary developing device 4 has a rotary member 45 as a rotatable support member supporting developing devices. The rotary member 45 includes developing devices 41, 42, 43, and 44 containing toner in yellow (Y), magenta (M), cyan (C), and black (K), respectively. The rotary member 45 is rotated at a predetermined timing for developing the electrostatic latent images corresponding to toner images in respective colors and successively formed on the photosensitive drum 1. In accordance with the rotation of the rotary member 45, the developing device for specified color is moved to an opposing portion (developing portion) to the photosensitive drum 1, followed by the development.

The image forming apparatus 100 includes a rotary drum type intermediate transfer member (hereinafter, referred to as “intermediate transfer drum”) as a second image bearing member. An intermediate transfer drum 5 is kept in press-contact with the photosensitive drum 1 with a given pressurizing force. A primary transfer nip portion N1 is formed between the photosensitive drum 1 and the intermediate transfer drum 5 as a transfer portion. The intermediate transfer drum 5 is rotated at a peripheral speed (process speed) somewhat different from that of the photosensitive drum 1 in a clockwise direction as indicated by the arrow of FIG. 1. At the primary transfer nip portion N1, a primary transfer roller 6 as primary transfer means is brought into contact with the photosensitive drum 1 through the intermediate transfer drum 5. A primary transfer bias is applied to the primary transfer roller 6 from a first bias source (not shown), which has a polarity (in this embodiment, a positive polarity) reverse to a toner charge polarity of an image (in this embodiment, a negative polarity). Thus, the toner images in respective colors formed in turn on the photosensitive drum 1 are transferred onto the intermediate transfer drum 5 in a superimposed form.

After the completion of the primary transfer, the surface of the photosensitive drum 1 is cleaned by cleaning off residual toner with a cleaning blade 14 as a cleaning member.

Next, transfer materials (sheet-like media) 24 are separated and conveyed one by one by a sheet feed roller 10 from a sheet feed cassette 9, and fed at a predetermined timing to a secondary transfer nip portion N2 as a transfer portion through a registration roller pair 11 and a transfer guide 12. In accordance with the timing, a secondary transfer roller 7 as secondary transfer means is brought into contact with the intermediate transfer drum 5 through a transfer belt 7a at the secondary transfer nip portion N2. The secondary transfer roller 7 is applied with a bias of the same polarity (in this embodiment, negative polarity) as the toner polarity of the composite color toner image after the primary transfer onto the intermediate transfer drum 5, from a second bias source (not shown). As a result, the toner images formed on the intermediate transfer drum 5 are collectively transferred onto a surface of the transfer material 24 fed to the secondary transfer nip portion N2.

The transfer material 24 to which the toner images on the intermediate transfer drum 5 have been collectively transferred by passing through the secondary transfer nip portion N2 is then guided into a fixing device 15. The transfer material 24 is applied with heat and pressure by a fixing roller 16 and a pressure roller 17 which are controlled to a predetermined temperature, at the fixing device 15. In the fixing device, the toner image is fixed thereonto and the transfer material is outputted to the outside of the image forming apparatus 100 as an image-formed print.

Meanwhile, transfer residual toner on the intermediate transfer drum 5 after the completion of the secondary transfer is cleaned off with a roller type intermediate transfer member cleaning device 18. More specifically, the intermediate transfer member cleaning device 18 is equipped with a conductive roller (contact charging member) contacting the intermediate transfer drum 5, by which charges with a polarity (in this embodiment, positive polarity) reverse to that of the toner in the developing device are applied to the toner on the intermediate transfer drum 5. The toner is reversely transferred onto the photosensitive drum 1 at the primary transfer nip portion N1 and then, carried to a cleaning portion and cleaned off with the cleaning blade 14.

(Toner)

In this embodiment, the following is adopted as the toner.

Toner (polymerization toner) obtained by suspension polymerization is produced by polymerizing a liquid monomer. Thus, it is possible to readily control a particle diameter by controlling a shearing stress and granulation temperature.

The allowable toner should contain at least two types of resin components (A and B) at a ratio of A:B=50:50 to 95:5 and be separated into a phase mainly containing the resin A and a phase mainly containing the resin B. The phase mainly containing the resin A is at a surface layer portion and the phase mainly containing the resin B is at a central portion. Preferred is a combination of the phase mainly containing the resin A with a high softening temperature and the phase mainly containing the resin B with a low softening temperature. Any combination can be adopted with no particular limitation insofar as the prepared toner causes phase separation into the phase mainly containing the resin A and the phase mainly containing the resin B.

Preferably, the resin A has a weight average molecular weight Mw of 5,000 to 200,000 measured by GPC and an outflow start point of 65 to 100° C. measured by a flow tester. Any resin obtained by suspension polymerization can be used as the resin A. Further, the resin may have a functional group serving as a charge site or a functional group that enhances an adhesion with paper.

The toner of the present invention has a volume average particle diameter of 6 to 9 μm.

Examples of the polymerizable monomers that may be used in the aforementioned suspension polymerization include: styrene monomers such as styrene, o-methylstyrene, m-methylstyrene, p-methylstyrene, p-methoxystyrene, and p-ethylstyrene; acrylates such as methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate, and phenyl acrylate; methacrylates such as methyl methacrylate, ethyl methacrylate, n-propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; and other monomers such as acrylonitrile, methacrylonitrile, and acrylamide.

Those monomers can be used singly or in mixture. Among those monomers, using styrene or styrene derivatives singly or in mixture with other monomers is preferred from the viewpoint o the developability and durability of the toner.

Preferably, the resin B has a weight average molecular weight Mw of 300 to 10,000 measured by GPC and a melting temperature of 30 to 130° C., more preferably 60 to 100° C. If the melting temperature is lower than 30° C., low-temperature offset etc. easily occur at the time of fixing, for instance, to produce an adverse effect. In contrast, if the melting temperature is higher than 130° C., the resin B is solidified at the time of producing the toner, resulting in insufficient granulation.

As the resin B, wax can be used. Examples of waxes include parafin, polyolefin wax, or its modified product, for example, oxides and grafted product, and in addition, higher aliphatic acid and its metal salts, and amide wax.

The component ratio between the resin A and the resin B satisfies A:B=50:50 to 95:5, preferably A:B=70:30 to 90:10. If the ratio of the resin B to the resin A is larger than 50% (i.e. 50:50) in percentage, a capsule structure cannot be maintained. If the ratio of the resin B to the resin A is smaller than 5% (i.e. 95:5) in percentage, the resin B cannot exert an effect.

In the present invention, the phase mainly containing the resin B does not exist in the vicinity of the surface (the depth from the toner surface is 0.15 times as large as the toner particle diameter). This conceptually means that the surface layer has a thickness 0.15 times larger than the toner particle diameter. However, even if the thickness 0.15 times as large as the particle diameter is not attained in some portions due to cracks etc., no problem arises unless the phase mainly containing the resin B is not included in the portion. If the phase mainly containing the resin B exists in the vicinity of the surface (the depth from the toner surface is 0.15 times as large as the toner particle diameter), the capsule structure cannot be maintained and anti-blocking property deteriorates, for instance.

The toner particle desirably has a substantially spherical shape in consideration of transferability etc. The values of factors (shape factors of the toner used in the present invention) SF-1 and SF-2 are defined as follows. That is, 100 toner images magnified at 200-fold to 5,000-fold magnification are sampled at random by using an FE-SEM “S-800” (manufactured by Hitachi, Co., Ltd.), the image information obtained based on the sampled images is inputted in an image analyzing device “Luzex3” (manufactured by Nicolet Japan Corporation) through an interface and analyzed, and then based on the analyzed results, the values are calculated from the following expressions:

$$Shape factor ( SF \text{-} 1 ) - \frac{{( MXLNG )}^{2}}{AREA} \times \frac{π}{4} \times 100$$

(where MXLNG represents an absolute maximum length of toner particles and AREA represents a projection area of the toner particles),

$$Shape factor ( SF \text{-} 2 ) - \frac{PERI}{AREA} \times \frac{1}{4 π} \times 100$$

(where PERI represents a peripheral length of the toner particles and AREA represents a projection are of the toner particles).
The shape factor SF-1 represents sphericity. The larger the factor SF-1, the lower the sphericity. The shape factor SF-2 represents a surface irregularity level. The larger the factor SF-2, the higher the surface irregularity level in a surface area.

Regarding the shape factors of the toner, the value of SF-1 is preferably 100 to 150, more preferably 100 to 120. The value of SF-2 is preferably 100 to 140, more preferably, 100 to 120. If the value of SF-1 exceeds 150 or the value of SF-2 exceeds 140, the transfer efficiency of the toner undesirably drops. As the toner shape factor SF-1 increases, the sphericity of the toner particle is lowered. If the value exceeds 120, the spherical toner characteristics are lost.

When the toner shape factor SF-2 increases, the surface irregularity level is high. If the value exceeds 120, the surface irregularity is more conspicuous, and the toner particles hardly move.

It is desirable to add a charge control agent to the toner material for the purpose of controlling the chargeability of the toner. As the charge control agent, the known materials showing almost no polymerization inhibiting property nor aqueous phase transfer property are used. Examples of positive charge control agents include amine or polyamine compounds such as nigrosine dyes, triphenyl methane dyes, and quaternary ammonium salts. Examples of negative charge control agents include metal-containing salicylate compounds, metal-containing monoazo dye compounds, styrene-acrylate copolymer, and styrene-methacrylate copolymer.

The known dyes or pigments may be used as the colorants, and examples thereof include: dyes such as carbon black, iron black, C.I. Direct Red 1, C.I. Direct Red 4, C.I. Acid Red 1, C.I. Basic Red 1, C.I. Mordant Red 30, C.I. Direct Blue 1, C.I. Direct Blue 2, C.I. Acid Blue 9, C.I. Acid Blue 15, C.I. Basic Blue 3, C.I. Basic Blue 5, C.I. Mordant Blue 7, C.I. Direct Green 6, C.I. Basic Green 4, and C.I. Basic Green 6; and pigments such as chrome yellow, cadmium yellow, mineral fast yellow, navel yellow, naphthol yellow S, hansa yellow G, permanent yellow NCG, tartrazine lake, molybdenum orange, permanent orange GTR, benzidine orange G, cadmium red, permanent red 4R, watching red calcium salt, brilliant carmine 3B, fast violet B, methyl violet lake, prussian blue, cobalt blue, alkali blue lake, victoria blue lake, quinacridone, rhodamine lake, phthalocyanine blue, fast sky blue, pigment green B, malachite green lake, and final yellow green G.

When the toner is obtained by the polymerization method, an attention should be paid to the polymerization inhibiting property of the colorant and the aqueous phase transfer property thereof. It is preferable to perform surface modification, e.g., hydrophobizing treatment with a substance with no property of inhibiting the polymerization. In particular, most of the dyes and the carbon black have the polymerization inhibiting property and require due consideration when in use. As a preferable method of surface-treating the dyes, there is a method of previously polymerizing polymerizable monomers in the presence of the dyes. The colored polymer obtained is added to the monomer system. As regards the carbon black, in addition to the same treatment as the dyes, the carbon black may be grafted with the substance reactive to the surface functional group of the carbon black, for example, polyorgano siloxane or the like.

(Cleaning Member)

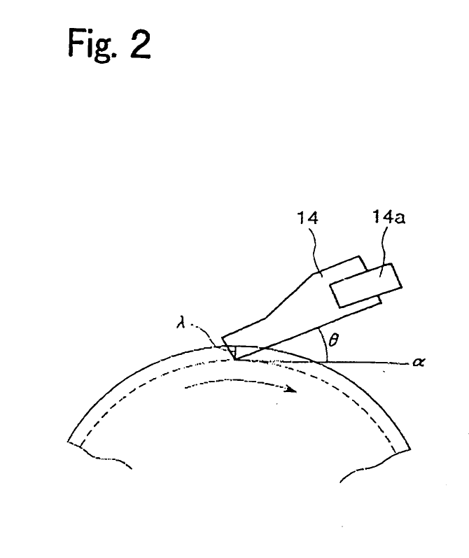

The cleaning blade 14 used in this embodiment is described in more detail. In this embodiment, the cleaning blade 14 has a shape shown in FIG. 2.

The cleaning blade 14 is made of an elastic material such as urethane rubber with a thickness of 1.6 mm. Also, in this embodiment, the Wallace hardness of the cleaning blade 14 is about 70° C. The cleaning blade 14 abuts against the photosensitive drum 1 under the conditions that a set angle θ with respect to the photosensitive drum 1 is 30°, and an inroad amount λ is 1.2 mm. A nip width “a” is about 100 μm when the drum is at rest. The cleaning blade 14 abuts against the photosensitive drum 1 while one side of an elastic plate is supported by a holder (holding member) 14a and a free end side thereof is directed to a upstream side in the rotation direction of the photosensitive drum 1.

Here, the Wallace hardness is measured by using, as a measuring device, the Wallace Hardness Tester (Model: H12) (manufactured by H W Wallace & Co., Ltd.) based on the IRHD hardness test M (micrometer) method under the measurement conditions of 25° C. and 50% RH.

However, the cleaning blade 14 may take any shape with no particular limitation as far as the transfer residual toner can be well cleaned off.

The hardness of the cleaning blade of the present invention is about 65° to 80° (based on the IRHD Wallace hardness).

As shown in FIG. 2, the set angle θ means the angle between the tangent α of the photosensitive drum 1 and the undeformed lower surface of the cleaning blade 14 in the figure (surface opposite to the photosensitive drum 1). In the case where the cleaning blade deforms, the set angle θ is defined as the angle between the tangent α at a point where a virtual outer periphery of the photosensitive drum 1 and the cleaning blade and the tangent of the cleaning blade.

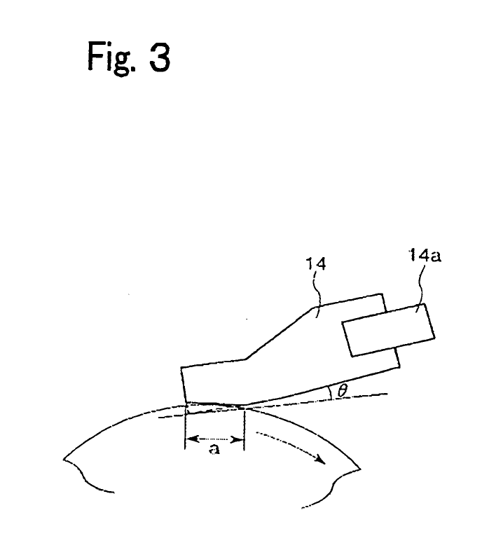

The inroad amount λ means an amount in which the leading edge (edge on the abutment side of the free end (undeformed side) of the cleaning blade 14) of the cleaning blade 14 enters there from the virtual outer periphery of the photosensitive drum 1. As shown in FIG. 3, the nip width a means the length of the portion where the cleaning blade 14 and the photosensitive drum 1 abut against each other, in the rotation direction of the photosensitive drum 1.

(Degree of Compaction of Toner and Cleaning Property)

As a result of extensive studies of the inventors of the present invention, the phenomenon that the toner particles slip through the blade largely depends on a degree of compaction of the toner. The inventors of the present invention have found out a relationship between an optimum range of the degree of compaction of the toner and the toner capable of showing the satisfactory cleaning property. In other words, the toner as the transfer residual toner carried to the cleaning portion deposits into a layer around an abutting portion between the cleaning blade 14 and the photosensitive drum 1. The convection thereof secures the cleaning property and the sliding property of the cleaning blade 14. With the low degree of compaction of toner, the connection between the toner particles is low, so that the toner not forms the deposit layer but is caused to flow. Also, the toner particles have spherical shapes and thus, impart the excessive sliding property to the cleaning blade 14. As a result, the toner easily slips through the cleaning blade 14. In contrast, the toner convection does not occur in the vicinity of the contact portion of the cleaning blade 14 with the photosensitive drum 1 if the degree of compaction of the toner is excessively increased. The toner slips through the cleaning blade 14 without imparting the sliding property to the cleaning blade 14.

The inventors of the present invention have measured the degree of compaction of the toner after applying to the spherical toner different types of silica in terms of particle diameter or treatment. The cleaning property is examined using the image forming apparatus 100 as structured above. Note that the silica used for the measurement has the following conditions.

Silica A: a raw material having BET value of 50 m²/g is hydrophobized.

Silica B: a raw material having a BET value of 90 m²/g is hydrophobized.

Silica C: a raw material having a BET value of 90 m²/g is hydrophobized and treated with oil.

Silica D: a raw material having a BET value of 50 m²/g is hydrophobized and treated with oil.

Silica E: a raw material having a BET value of 200 m²/g is hydrophobized and treated with oil.

Samples 1 to 5 are obtained by adding 0.7 part by weight each of silica and titanium oxide as external additives to 100 parts by weight of toner. Sample 6 is obtained by adding 0.7 part by weight of the silica D alone. Sample 7 is obtained by adding the silica D in a smaller amount (i.e., 0.3 part by weight) for the high degree of compaction. The titanium oxide added to Samples 1 to 7 except for Sample 6 is obtained by hydrophobizing a raw material having a BET value of 100 m²/g.

Note that the cleaning property is examined as well in the case of changing the inroad amount λ of the cleaning blade 14 from the above set value (1.2 mm). The cleaning property is examined in a testing room at room temperature (about 23° C.) and moisture of about 5%, the apparatus main body with the same structure of the image forming apparatus 100 is set and fully adapted thereto, after which 10 sheets are printed out under the condition that A3-size toner image with a toner bearing amount on the photosensitive drum of about 0.7 mg/cm² is not primarily transferred and then, the toner slipping-through level from the cleaning blade is examined. The results are shown in Table 1.

Note that, the measurement on the degree of compaction is performed as follows.

Measurement of degree of compaction: the degree of compaction is used as a reference for judging the flowability of the toner containing the external additives. The larger degree of compaction is assumed to involve the more deteriorated flowability of the sample. As a measuring device, a powder tester (manufactured by HOSOKAWA MICRON Co. LTD. (model: PT-N) is used. A measurement method is described next. A 400-mesh sieve (sieve opening: 150 μm), a 200-mesh sieve (sieve opening: 75 μm), and a 100-mesh sieve (sieve opening: 38 μm) are overlaid on top of one another from above in the order of increasing sieve opening, and 5 g of the sample is placed on the 100-mesh sieve. After applying an oscillation with an amplitude adjusted to 0.5 mm and a frequency of 50 Hz (3,000 v.p.m) to the 100-mesh sieve for 15 seconds, a weight of sample remaining on each of the sieves is measured to obtain the degree of compaction based on the following expression. Note that the stainless steel mesh is used.

$$Degree of compaction C ( \% ) = \frac{\begin{matrix}Weight of toner on \\ 100 - mesh sieve ( g )\end{matrix}}{5 g} \times 100 + \frac{\begin{matrix}Weight of toner on \\ 200 - mesh sieve ( g )\end{matrix}}{5 g} \times 100 \times \frac{3}{5} + \frac{\begin{matrix}Weight of toner on \\ 400 - mesh sieve ( g )\end{matrix}}{5 g} \times 100 \times \frac{1}{5}$$

The sample that has been left standing under the environment of 23° C. and 60% RH for about 48 hours is used as it is without stirring. The measurement environment is as follows: a temperature is 23° C. and humidity is 60% RH.

TABLE 1

| | | | | | Degree of | | | | | |
|---|---|---|---|---|---|---|---|---|---|---|
| | | | | | compaction | Blade inroad amount | | | | |
| | | Addition amount | Titanium | Addition amount | of toner | λ (mm) | | | | |
| No. | Silica | (part by weight) | oxide | (part by weight) | (%) | 0.75 | 0.9 | 1.2 | 1.5 | 1.6 |
| 1 | Silica A | 0.7 | Titanium A | 0.7 | 19 | x | ∘ | ∘ | ∘ | x |
| 2 | Silica B | 0.7 | Titanium A | 0.7 | 11 | x | ∘ | ∘ | ∘ | x |
| 3 | Silica C | 0.7 | Titanium A | 0.7 | 15 | x | ∘ | ∘ | ∘ | x |
| 4 | Silica D | 0.7 | Titanium A | 0.7 | 22 | x | ∘ | ∘ | ∘ | x |
| 5 | Silica E | 0.7 | Titanium A | 0.7 | 8 | x | x | x | x | x |
| 6 | Silica D | 0.7 | | 0 | 28 | ∘ | ∘ | ∘ | ∘ | x |
| 7 | Silica D | 0.3 | Titanium A | 0.7 | 33 | x | x | — | — | — |

∘: No toner slips through the blade
x: Toner slips through the blade
—: Cleaning blade does not slide and the toner slips through the cleaning blade

As apparent from the results of Table 1, the satisfactory cleaning property can be obtained within the range of 10 to 30% of the degree of compaction excluding the case where the inroad amount λ is 1.6 mm (Samples 1 to 4, and 6). The sample showing the degree of compaction of toner which is lower than 10 involves the toner slippage at every inroad amount (Sample 5). When the degree of compaction of the toner exceeds 30%, the cleaned-off toner deposits in the vicinity of a cut edge of the cleaning blade 14 to impart any stress on the cleaning blade 14, with the result that a cleaning failure occurs (Sample 7). The frictional force between the cleaning blade 14 and the photosensitive drum 1 is increased if the inroad amount λ is set to 1.6 mm or more in every sample. In the end, the cleaning blade 14 cannot smoothly slide (move) on the photosensitive drum 1 and thus the drive load rapidly increases, letting the toner slip through the blade.

In this way, a degree of compaction C of the toner is set to fall within a range of 10 to 30%, making it possible to prevent toner from slipping through the blade. More preferably, a degree of compaction C of the toner is set to fall within a range of 15 to 28%. Note that the degree of compaction of the sample is adjusted by changing the BET value of silica or titanium oxide as an external additive, the way of surface treatment, and the addition amount thereof in this experiment. However, the present invention is not limited to the above but may adopt another method of adjusting the degree of compaction. For example, the average particle diameter of the toner itself is changed to adjust the degree of compaction, which produces the same effects as well.

As mentioned above, according to this embodiment, it is possible to keep a stable cleaning performance with no toner slippage.

### Second Embodiment

Next, another embodiment of the present invention is described. Basic structure and operation of the image forming apparatus of this embodiment are the same as the image forming apparatus 100 of the first embodiment. Hereinafter, description is made focusing the feature of this embodiment.

This embodiment has a feature that the toner slippage through the cleaning blade 14 is avoided as mentioned in the first embodiment, and in addition, the noise generated by the unstable behavior of the cleaning blade 14 is prevented.

That is, this embodiment has a feature that in the image forming apparatus shown in FIG. 1, the degree of compaction C of the toner is set to fall within the range described in the first embodiment, and at the same time, the set angle 0 of the cleaning blade 14 to the photosensitive drum 1 is set to 27° or smaller.

In general, if the set angle of the blade increases, the same inroad amount of the blade leads to the enhanced cleaning performance. However, if the set angle 0 exceeds 27°, the cleaning performance can be kept, but an RF noise, i.e., a so-called blade noise may occur depending on the temperature and the humidity conditions, or the like. This is because the behavior of the cleaning blade 14 is unstable and the weak vibrations are transmitted to the photosensitive drum 14. The resonance occurs in the cylinder of the photosensitive drum 14 and the unpleasant noise is generated.

Note that, the set angle θ is preferably set to 18° or larger and 36° or smaller in terms of the cleaning property.

Table 2 shows the result of studies on the cleaning property at the time of 500-sheet passing operation and the generation of the noise of the blade while changing the set angle θ of the cleaning blade 14.

TABLE 2

| | Degree of | | |
|---|---|---|---|
| Blade | compaction | | |
| setting angle | of toner | Cleaning | Blade |
| (°) | (%) | property | noise |
| 23 | 22 | ∘ | ∘ |
| 27 | 22 | ∘ | ∘ |
| 30 | 22 | ∘ | x |

∘: Practically allowable
x: Practically unallowable

As shown in Table 2, the set angle θ of the cleaning blade 14 is 30°, the cleaning property can be secured, but the noise of the cleaning blade 14 is generated. On the other hand, the set angle θ is 27° or smaller, the noise of the cleaning blade 14 is not generated.

As described above, according to this embodiment, while maintaining the cleaning property against the transfer residual toner by setting a proper degree of compaction of toner as in the first embodiment, effects of stabilizing the behavior of the blade leading edge and suppressing the blade noise can be attained.

### Third Embodiment

Next, another embodiment of the present invention is described.

Overall Structure and Operation of Image Forming Apparatus)

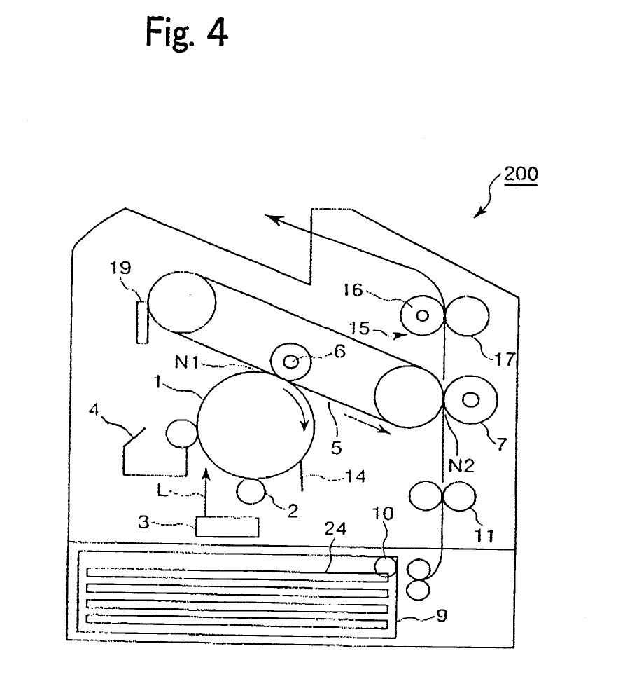

FIG. 4 is a schematic diagram showing an image forming apparatus 200 according to this embodiment. In FIG. 4, the same or equivalent components as or to the image forming apparatuses according to the first and second embodiments are denoted by the same reference numerals. Basic structure and operation of the image forming apparatus 200 of this embodiment are almost the same as those of the first and second embodiments.

In this embodiment, the belt-type intermediate transfer belt 5 as the intermediate transfer member is provided as the second image bearing member. In this embodiment, the single-color developing device 4 is used as the developing means. The toner image formed on the photosensitive drum 1 is immediately transferred onto the intermediate transfer belt 5 at the primary transfer nip portion N1 and then transferred onto the transfer material 24 at the secondary transfer nip portion N2. Note that the present invention is not limited to this. Needless to say, for example, as shown in FIG. 1, as the developing means, the rotary developing device including the plural developing devices may be provided, by which the color-image can be formed.

The transfer residual toner on the surface of the photosensitive drum 1 after the primary transfer is cleaned off with the cleaning blade 7 as the cleaning member. On the other hand, the transfer residual toner on the intermediate transfer belt 5 after the secondary transfer is cleaned off with the blade type intermediate transfer member cleaning device (intermediate transfer member cleaning blade) 19.

As in the image forming apparatus 100 in the first and second embodiments, in this embodiment, the conductive roller that contacts the photosensitive drum 1 is used as the charging means and the charging bias obtained by superimposing on the DC voltage the AC voltage is applied to the conductive roller. Also, the toner used in the developing device 4 is polymerization toner similar to that of the first and second embodiments.

(Cleaning Member)

The cleaning blade 14 used in this embodiment is described in detail. In this embodiment, the cleaning blade 14 has substantially the same structure and shape as the first and second embodiments.

The cleaning blade 14 used is made of an elastic material (urethane rubber) with the thickness of 1.6 mm. In this embodiment, the Wallace Hardness of the cleaning blade 14 is about 70°. The cleaning blade 14 abuts against the photosensitive drum 1 under the conditions that the set angle θ with respect to the photosensitive drum 1 is 24°, and the inroad amount λ is 1.2 mm. A nip width “a” is about 100 μm when the apparatus is at rest.

However, the cleaning blade 14 may take any shape with no particular limitation as far as the transfer residual toner is cleaned off in a satisfactory manner.

(Toner Degree of Compaction and Glade Noise/Turning Up)

As a result of extensive studies of the inventors of the present invention, it is found that the occurrence of the noise or turning up of the cleaning blade 14 just after power-on of the image forming apparatus 200, which is particularly remarkably observed upon applying the AC bias to the charging means, correlates to the arrangement of the cleaning blade 14 relative to the photosensitive drum 1 and the degree of compaction of the polymerization toner.

As described above, it is known that the degree of compaction of polymerization toner varies according to the particle diameter, kind, and content of the extraneous additive used. As compared with conventionally used pulverized toner, polymerization toner, the production of which involves bonding reaction of molecules in a suspension, exhibits no surface irregularities and has a surface property that is approximately close to a true sphere. Further, polymerization toner has a structure in which it contains wax in its interior, and thus a wax component is not exposed to the surface thereof. When agglomerated, particles of such a polymerization toner can easily form closest packing; when this is left as it is and once the particles are allowed to agglomerate, they cannot be easily dispersed. Therefore, polymerization toner tends to compare poorly with pulverized toner in terms of the ease of deposition, and hence ease of convection, of toner in the vicinity of the cut edge of the cleaning blade 14.

When the toner for which the formulation of the extraneous additive has been changed has an extremely high degree of compaction, the toner particles accumulating near the cut edge of the cleaning blade 14 form an agglomerate upon turning-off of the image forming apparatus 200. When, in particular, the cleaning blade 14 is located below the photosensitive drum 14 that is a member to be cleaned, the agglomerated toner particles drop by their own weights to a waste toner container (not shown) due to oscillation between the cleaning blade 14 and the photosensitive drum 1 caused by the application of the AC/DC bias in the primary charging operation, without undergoing convection near the cut edge of the cleaning blade 14. Thus, it is impossible to impart slidability to the cleaning blade 14. As a result, the friction between the cleaning blade 14 and the photosensitive drum 1 increases, causing the blade to generate noise.

In contrast, in the case where the degree of compaction of the toner is low, when supplied to the cleaning region, transfer residual toner jets out upon its collision against the blade, causing the toner to be scattered from the vicinity of the cut edge of the cleaning blade 14. Thus toner depletion occurs in the cleaning region. Then, immediately after turning on the image forming apparatus 200 again, the friction between the cleaning blade 14 and the photosensitive drum 1 increases, causing noise or turning up of the blade.

The inventors of the present invention measured the degree of compaction of spherical toner after adding thereto silicas having different particle diameters and formed through different treatments, and then checked the noise of the blade by using the image forming apparatus 200 constructed as described above. After performing printing of 500 sheets with the image forming apparatus 2 constructed as described above, the power of the apparatus main body was turned off. After left to stand for two days, the apparatus main body was turned on again to perform printing of 100 sheets.

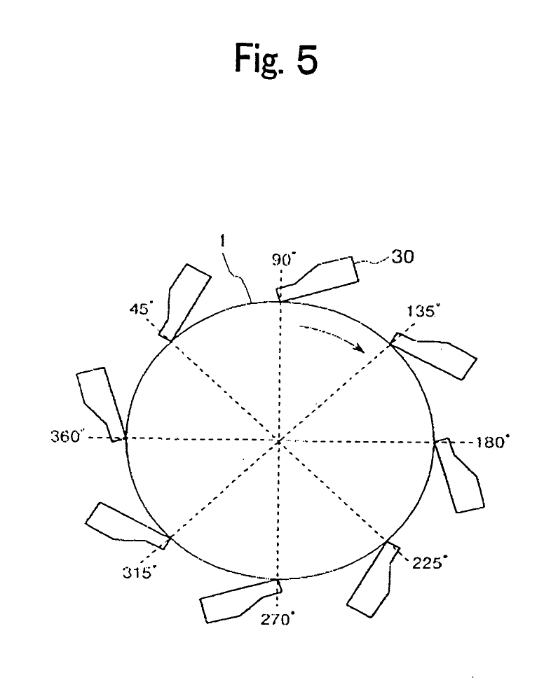

Table 3 shows results of observation on the noise of the cleaning blade 14 and the toner retention when polymerization toner having its degree of compaction adjusted to 33% is used. The results are shown for cases in which, as shown in FIG. 5, a contact position P of the cleaning blade with the photosensitive drum 1 as represented by an angle is changed to 0° (360°), 45°, 90°, 135°, 180°, 225°, 270°, and 315°. The above angle is a clockwise-increasing angle that is formed between a line connecting the left end position on the outer periphery of the photosensitive drum 1 to the rotation center of the photosensitive drum 1 and a line connecting the contact position P to the rotation center, when viewing the photosensitive drum 1, which is a rotary member having a circular cross section, from its one end side in the longitudinal direction so that its outer periphery appears circular (in this case, when viewing the photosensitive drum 1 from the direction in which the photosensitive drum 1 appears as rotating in the clockwise direction).

TABLE 3

| Arrangement of | Retention of | |
|---|---|---|
| blade (°) | toner | Blade noise |
| 45 | ∘ | ∘ |
| 90 | ∘ | ∘ |
| 135 | ∘ | ∘ |
| 180 | ∘ | ∘ |
| 225 | x | x |
| 270 | x | x |
| 315 | x | x |
| 360 | x | x |

Retention of toner
∘: Excellent retention
x: Poor retention
Blade generates noise
∘: Blade generates noise
x: Blade does not generate noise

As shown in Table 3, when the degree of compaction C of the toner is 33%, the toner drops off when the contact position P of the cleaning blade 14 with the photosensitive drum 1 falls within the range of 180° to 360°, and the cleaning blade 14 generates noise.

Table 4 shows comparison results obtained by observing the noise of the cleaning blade 14 in a case where the contact position P of the cleaning blade 14 with the photosensitive drum 1 is changed to four positions of 90°, 180°, 270°, and 360°, while varying the degree of compaction of toner to 8%, 12%, 16%, 28%, and 33%.

TABLE 4

| Arrangement | Degree of compaction of toner (%) | | | | |
|---|---|---|---|---|---|
| of blade (°) | 8 | 12 | 16 | 28 | 33 |
| 90 | ∘ | ∘ | ∘ | ∘ | ∘ |
| 180 | ∘ | ∘ | ∘ | ∘ | ∘ |
| 270 | x | Δ | ∘ | Δ | x |
| 360 | x | Δ | ∘ | Δ | x |

∘: Blade generates noise
Δ: Blade generates some noise, but the level of noise presents no practical problem
x: Blade does not generate noise

The results shown in Table 4 indicate that, when the arrangement of the cleaning blade 14 is one (180° to 360°) that is liable to cause depletion of toner in the cleaning portion, the noise of the blade can be favorably prevented by restraining the degree of compaction C of toner to be within a range of 10% to 30%. More preferably, the degree of compaction C of toner is set to be within a range of 15% to 28%.

By setting the degree of compaction of toner as described above, it is also possible to prevent turning up of the blade 14 which tends to occur in a manner similar to the noise of the cleaning blade 14.

As described above, according to this embodiment, it is possible to eliminate, in particular, the noise or turning up of the cleaning blade 14 occurring immediately after the power is turned on.

### Fourth Embodiment

Next, still another embodiment of the present invention is described. This embodiment is a modification of the third embodiment.

This embodiment aims to more reliably attain the effect of suppressing noise of the cleaning blade 14, which becomes a problem when turning on the image forming apparatus that has been left idle.

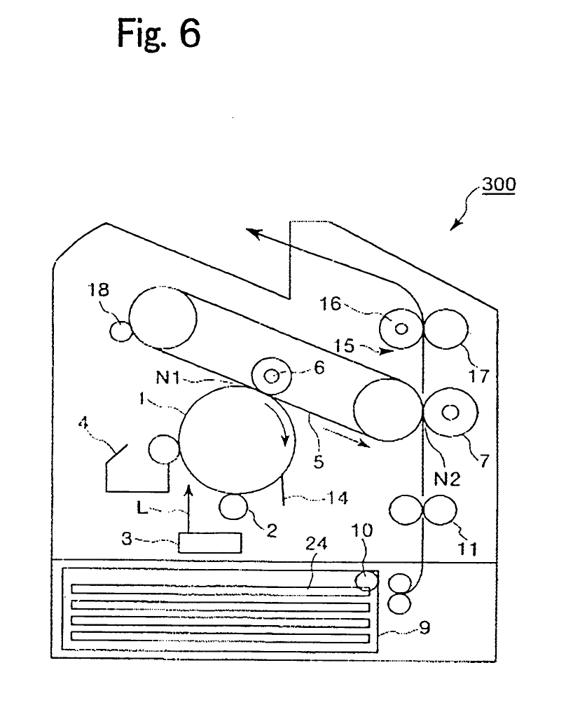

FIG. 6 shows the general construction of an image forming apparatus 300 according to this embodiment. The image forming apparatus 300 according to this embodiment is of generally the same construction as the image forming apparatus 200 of the fourth embodiment (shown in FIG. 4), and differs therefrom only in the cleaning method for the intermediate transferring belt 5.

In this embodiment, transfer residual toner on the intermediate transfer belt 5 is removed by using the roller type intermediate transfer member cleaning device 18. That is, the intermediate transfer member cleaning device 18 is equipped with the conductive cleaning roller (contact charging member) that rotates while abutting the intermediate transferring belt 5. Then, by applying to the roller a bias having a polarity opposite to the charging polarity of the toner, the toner is revered in polarity and transferred again onto the photosensitive drum 1 in the primary transfer nip portion N1, to be supplied to the cleaning portion of the photosensitive drum 1, that is, the contact position of the cleaning blade 14 with the photosensitive drum 1.

Polymerization toner is excellent in chargeability and transferability due to its sphericity. Thus, when only low-density images are printed, transfer residual toner may not be transferred to the cleaning portion.

In this embodiment, as described above, even the toner that remains on the intermediate transferring belt 5 after the secondary transfer is supplied to the contact portion between the cleaning blade 14 and the photosensitive drum 1, thereby preventing toner depletion from occurring near the cut edge of the cleaning blade 14.

The above-described method of this embodiment is particularly effective when used for a structure in which a deterioration in secondary transfer efficiency occurs, such as when color-image formation is performed by using an intermediate transfer member.

### Other Embodiments

While the above embodiments adopt a non-magnetic one-component developing method using polymerization toner for the developing unit, a further study is conducted by changing the developing method to a two-component developing method using magnetic carrier. Then, the same results as those of the above embodiments were obtained, and hence the effects of the present invention were observed, also in an endurance test for 5000 sheets in which ferrite and nickel powder were used as the carrier.

In the above embodiments, the description is directed to the case in which the transfer material, to which the toner image is transferred from the image bearing member, is the intermediate transfer member. However, the present invention is not limited to this. For example, the present invention can be applied to an image forming apparatus in which the toner image formed on the image bearing member is directly transferred to the transfer material. Further, the present invention is equally applicable to an image forming apparatus employing a multiple-transfer-on-transfer-material method that is well known to a person skilled in the art, in which a transfer-material carrying member is provided instead of the intermediate transfer member and toner images are repeatedly transferred to the transfer material on the above-mentioned transfer-material carrying member before being fixed thereto. Further, the present invention is applicable even when the image bearing member, which is the member to be cleaned, is the intermediate transfer member, if a cleaning device using an elastic rubber blade is used.

As described hereinabove, according to the present invention, it is possible to prevent toner from slipping through the cleaning member even when polymerization toner, cleaning of which is difficult when it is present as transfer residual toner, is used. Further, even when toner does not easily accumulate on the cleaning region due to the manner in which the cleaning member is placed, toner present in the vicinity of the cleaning member is not depicted, and in particular, noise or turning up of the cleaning member can be prevented from occurring immediately after the power is turned on. As a result, the cleaning performance of the cleaning member can be maintained over a long period of time, making it possible to form high-quality images at all times.

1. An image forming apparatus comprising:
an image bearing member;
a counter-type blade for removing toner formed on the image bearing member,
wherein: assuming that the blade inroads into the image bearing member, an inroad amount λ (mm) of the blade is 0.9≦λ≦1.5; an angle θ formed between the blade and a tangential plane of the image bearing member in an abutting portion of the blade with the image bearing member is 18°≦θ<90°; a volume average particle diameter of the toner is not smaller than 6 μm and not larger than 9 μm; a value of a toner shape factor SF-1 is not smaller than 100 and not larger than 120; and a degree of compaction C of the toner is not smaller than 10% and not larger than 30%,
wherein the degree of compaction of the toner is measured with a measurement method and is obtained based on an expression (1),
said measurement method in which a 400-mesh sieve (sieve opening: 150 μm), a 200-mesh sieve (sieve opening: 75 μm), and a 100-mesh sieve (sieve opening: 38 μm) are overlaid on top of one another from above in the order of increasing sieve opening, and 5 g of the toner is placed on the 100-mesh sieve, and a weight of toner remaining on each of the sieves after applying an oscillation having an amplitude of 0. 5 mm and a frequency of 50 Hz to the 100-mesh sieve for fifteen seconds is measured to obtain the degree of compaction C based on the following expression (1):
degree of compaction C (%)=a weight of toner on the 100-mesh sieve (g) 5(g)×100+a weight of toner on the 200-mesh sieve (g) 5(g)×35+a weight of toner on the 400-mesh sieve (g) 5(g)×15 (1).

2. An image forming apparatus according to claim 1, wherein said angle θ is preferably 18°≦θ≦36°.

3. An image forming apparatus according to claim 1, wherein a value of a toner shape factor SF-2 of the toner is not smaller than 100 and not larger than 140.

4. An image forming apparatus according to claim 1, wherein the toner is manufactured by a polymerizing method.

5. An image forming apparatus according to claim 1, wherein the angle θ satisfies 18°≦θ≦27°.

6. An image forming apparatus comprising:
an image bearing member;
a counter-type blade for removing toner formed on the image bearing member, the blade having an abutting portion which is brought into abutment against the image bearing member and arranged within ±90 degrees in a rotational direction of the image bearing member from a lowermost point in a gravitational direction on the image bearing member,
wherein: assuming that the blade inroads into the image bearing member, an inroad amount λ (mm) of the blade is 0.9≦λ≦1.5; an angle θ formed between the blade and a tangential plane of the image bearing member in the abutting portion of the blade with the image bearing member is 18°≦θ≦36°; a volume average particle diameter of the toner is not smaller than 6 μm and not larger than 9 μm; a value of a toner shape factor SF-1 is not smaller than 100 and not larger than 120; and a degree of compaction C of the toner is not smaller than 12% and not larger than 28%.
